(19) United States
(12) Patent Application Publication
(10) Pub. No.: US 2010/0093454 A1
(43) Pub. Date: Apr. 15, 2010

(54) BASE FOR A PLAYING FIELD

(75) Inventors: FRANK EDWARD BALL, NOOSA HEADS QLD (AU); PAUL LESLIE, MANLY QLD (AU)

Correspondence Address: CANTOR COLBURN, LLP, 20 Church Street, 22nd Floor, Hartford, CT, 06103, US

(73) Assignee: GREENGAUGE PTY LTD, MANLY QLD (AU)

(21) Appl. No.: 12/556,049

(22) Filed: Sep. 9, 2009

Related U.S. Application Data
(63) Continuation of application No. 10/587,624, filed on Jul. 26, 2006, now abandoned.

(51) Int. Cl. A63C 19/00; B05D 1/36

(52) U.S. Cl. 472/92; 427/203

(57) ABSTRACT

A base for a playing field comprises a layer of particulate material forming at least an upper part of the base and a binder applied to the layer of particulate material. The binder extends from about 5 mm to about 150 mm into the layer of particulate material. The binder acts to bind at least the uppermost part of the layer of particulate material. The layer is porous to water such that water applied to a surface of the base flows through said layer. The binder may be based on a silicate binder.

### CROSS-REFERENCE TO RELATED APPLICATIONS

This application is a continuation of U.S. patent application Ser. No. 10/587,624 filed 26 Jul. 2006 which was a national stage filing under 35 U.S.C. 371 with respect to International Patent Application No. PCT/AU2005/001931 filed 20 Dec. 2005, both of which said applications are herein incorporated by reference in their entirety.

### TECHNICAL FIELD OF THE INVENTION

The present invention relates to a base for a playing field. The present invention also relates to a method for forming a base for a playing field and to a binder composition for use in forming a base for a playing field. The base is particularly suited to use in playing fields that have a synthetic turf playing surface.

### BRIEF DISCUSSION OF RELATED ART

Synthetic turf playing fields are becoming more desirable. For example, in Australia, bowling rinks for lawn bowls are traditionally natural grass rinks. Such rinks must be rolled to a short length to ensure desirable roll characteristics of the lawn bowls on the grass. Typically, such rinks are also rolled to ensure that the ground beneath the grass is hard and flat. Unfortunately, the combination of short grass and rolling tends to have detrimental affects on the quality of the grass. A further complicating factor that has arisen in recent times relates to drought conditions that are becoming more frequent across Australia. During periods of drought, water restrictions are frequently imposed and lawn bowls clubs experience difficulty in maintaining adequate watering of the grass on the lawn bowls rinks to keep the grass alive.

For the above reasons, there has been renewed interest in recent years for providing lawn bowls rinks having synthetic turf surfaces.

Synthetic turf is in frequent and widespread use as a surface for sporting fields such as tennis courts, hockey fields, baseball fields, soccer fields and fields for use in other codes of football, particularly American gridiron. Synthetic turf is becoming a more attractive option as a playing surface for many modern stadiums which include a retractable roof or a wholly located indoors. It will be appreciated that difficulties can be experienced in growing grass in modern stadiums that have retractable rooves or are wholly indoors.

In order to provide a synthetic turf surface to a playing field, it is normally necessary to lay the synthetic turf over a base. The base should preferably be flat and perfectly level. Typical base constructions for synthetic turf playing fields incorporate either a concrete base (typically used in tennis courts) or a base that comprises a levelled bed of particulate material, such as sand or gravel. The level bed of particulate material is typically prepared by laying the particulate material, compressing or compacting the particulate material to form a firmer layer and levelling the particulate material. Sub-surface drainage is normally incorporated under the layer of particulate material. The synthetic turf is then laid on top of the compacted and levelled layer of particulate material. This synthetic turf is usually filled with separate particulate material, such as sand or pulverized rubber, to assist in holding down the synthetic turf.

Problems have arisen in such playing surfaces in that the layer of particulate material can move and shift over time. This can lead to accelerated wear of the synthetic turf and also uneven footing for players using the playing surface.

### BRIEF SUMMARY OF THE INVENTION

The invention provides an alternative base for a playing field.

In a first aspect, the present invention provides a base for a playing field comprising a layer of particulate, said layer forming at least an upper part of the base, and a binder applied to the layer of particulate material, the binder extending from about 5 mm to about 150 mm into the layer of particulate material, the binder acting to bind at least the uppermost part of the layer of particulate material, said layer being porous to water such that water applied to a surface of the base flows through said layer.

In one embodiment, the particulate material in the top layer is sized such that the particulates predominantly fall within the size range of 0.025 mm to 25 mm. In some embodiments, the particulates may predominantly fall within the size range of 0.025 mm to 10 mm, more preferably from 0.025 mm to 7 mm. In some embodiments, the particulate material is sized such that the particles predominantly are sized below 5 mm. In other embodiments, particulate matter having a larger particle size range, for example, falling in the upper part of the range of 0.025 mm to 25 mm particle size range, may be used.

The particulate material is suitably crushed stone, such as a crushed stone classed as a manufactured sand, a concrete crushed stone or a crusher dust. Such products are widely commercially available and will be readily known to the person skilled in the art. Suitable particulate material may be purchased from, for example, Hansen (Australia/UK), Readymix (Australia/USA), Winstons/Brokby (New Zealand) and Tarmac, Barden, Aggregate Industries, Midland quarry products, United Kingdom.

The layer of particulate material suitably forms a top layer of the base. For convenience, hereinafter throughout this specification, this layer will be referred to as the “top layer”.

The top layer may be laid directly onto an underlying concrete or asphalt base. Alternatively, the top layer may be laid onto an underlying layer of particulate material. The underlying layer of particulate material may suitably be a layer of graded particulate material having high permeability to water. The underlying layer or sub-layer of particulate material may comprise a graded layer having particles largely in the range of 7 mm to 22.5 mm. This layer may comprise a road base material, a filter rock, a graded gravel or the like. This sub-layer acts as a drainage aggregate to allow water to easily flow therethrough. As a further alternative, a single layer of particulate material may be used and the binder applied to the upper surface (at least) of that layer.

Suitably, sub-surface drainage is incorporated beneath the top layer.

Suitably, the sub-layer may have falls or slopes built-in during construction to enable water to run off the sub-layer.

The sub-layer may be porous or it may be substantially impermeable to water.

The binder is used to bind together at least the uppermost part of the top layer of particulate material. In this fashion, the uppermost part of the top layer remains stable during normal use of the playing field.

The binder is suitably applied to the layer of particulate material in the form of a liquid. The liquid may be a solution, an emulsion or a dispersion. The liquid binder desirably penetrates into the layer of particulate material to the desired degree before it cures or sets. The liquid binder may have rheological properties that are controlled such that the binder can penetrate to the desired degree prior to setting. The liquid binder is suitably applied by spraying.

The binder preferably comprises a silicate-based binder. More preferably, the binder comprises a sodium silicate-based binder. Sodium silicate binders may be purchased from PQ Corporation, of Berwyn, Pa. or PQ Australia Pty Ltd of Dandenong, Victoria, Australia or PQ Nederland B.V. Wischoten in the Netherlands. The silicate-based binder used in embodiments of the present invention is suitably a liquid silicate-based binder.

The binder may include a surfactant to increase or control penetration of the binder into the particulate layer. Any type of surfactant that achieves the depth of penetration and does not adversely affect the setting process may be used in the present invention. These may include anionic surfactants, cationic surfactants, non-ionic surfactants, amphoteric surfactants and mixtures of two or more thereof.

Desirably, the surfactant(s) is used to achieve the depth of penetration required for the particular sports surface being constructed. The surfactant(s) desirably improve the action of the binder by giving better dispersion of the binder in the particulate layer without affecting the permeability of the set mass to water.

The binder may also include one or more setting agents to control setting of the binder. The setting agent(s) may be selected from any setting agents capable of causing of setting of the binder system used. For example, for silicate-based binders, examples of suitable settings agents include organic/aliphatic esters or amides, such as formamide, glyoxal, acetates or acetins, and dibasic esters, as well as organic carbonates, such as propylene carbonate, and alcohols, particularly polyhydroxy alcohols, such as ethylene glycol and propylene glycol, and organic acids such a acetic acid, formic acid and carbonic acid. Other setting agents may also be used.

The setting agents act to accelerate the rate of setting of the silicate-based binder. Without the setting agents, the liquid silicate could run through the layer of particulate material before it sets and thereby leave behind insufficient silicate to properly bind the layer of particulate material. This could result in inadequate binding and hence unsatisfactory strength and durability in the top layer of the base.

It is also important that the setting agents be added in an amount such that setting of the binder is not accelerated to such an extent that the silicate sets before adequate penetration of the binder into the top layer of particulate material has occurred. The present inventors have found that setting times preferably fall within the range of 30 seconds to 30 minutes, more preferably from one minute to 20 minutes, even more preferably from 5 minutes to 15 minutes, most preferably from 8 minutes to 12 minutes, provide satisfactory results. The amount of setting agent added to obtain the desired setting times will depend upon the rate of acceleration of setting caused by the particular setting agents used and the temperature at which the binder is applied to the layer. Generally, where the binder is applied in cold climates, a greater amount of setting agents should be used or a more rapidly acting setting agent should be used.

Silicate-based binder systems that incorporate one or more setting agents in the final binder composition applied to the particulate layer will typically start to set as soon as the silicate component is mixed with the setting agent. For this reason, it is desirable to mix the one or more setting agents with the silicate component just prior to or during application of the final binder position to the particulate layer. This may be achieved, for example, by having separate containers containing the silicate component and the setting agent and mixing the components from the respective containers as part of the application process. For example, a metering pump having an inlet connected to the container containing the silicate component and another inlet connected to the container containing the setting agent may be used to mix the components and to supply the mixture to a spray nozzle for application to the particulate layer.

The binder suitably extends from about 5 mm to about 100 mm into the layer of particulate material. Preferably the binder penetrates at least 10 mm, more preferably at least 15 mm into the top layer of particulate material. It is especially preferred that the binder penetrates from 15 mm to 35 mm, more preferably from 20 mm to 25 mm. Penetration of from 20 mm to 25 mm has been found to be useful in providing a base having a top layer with good strength without requiring use of excessive amounts of binder.

The binder is suitably applied to the layer of particulate material at an application rate of from 0.5 litre per square metre to 10 litres per square metre, more preferably from 1 litre per square metre to 7 litres per square metre, even more preferably from 1 litre to 5 litres per square metre.

Once the binder has set, the top layer of the base surprisingly retains porosity and allows water to flow therethrough. This is a significant advantage of the base in accordance with the present invention because water does not tend to pool on the surface of the sporting field following rain. This allows play to resume quickly after rain and also minimizes maintenance required on the top surface of the playing field.

The bound top layer of the base of the present invention also has significant strength. The bound layer may exhibit a compressive strength of from 5 MPa to 18 MPa Testing of compressive strength was conducted using a Nuclear Densometer.

In a second aspect, the present invention provides a method for forming a base for a playing field comprising the steps of forming a base having at least an upper layer of a particulate material sized such that the particles predominantly fall within the size range of 0.025 mm to 10 mm and applying a liquid binder to the top layer such that the liquid binder penetrates a distance of from 5 mm to 100 mm into the top layer and sets to bind the particulate material in the top layer, wherein said top layer retains porosity to water.

In one embodiment, the liquid binder used in the present invention comprises a silicate-based binder, such as a sodium silicate-based binder.

In some embodiments, the silicate-based binder incorporates a silicate component and one or more setting agents. As the silicate component will typically commence setting upon mixing with the one or more setting agents, it is preferred in this embodiment of the invention that the silicate component and the one or more setting agents be mixed just prior to application of the binder to the top layer or mixed as part of the application process for applying the binder to the top layer. Suitably, the binder comprises a first composition including the silicate component and a second composition including the one or more setting agents. The first composition and the second composition are suitably stored in separate containers and are mixed either just prior to application or as part of the application process.

In this embodiment of the method of the present invention, the second composition may further include one or more surfactants.

The liquid binder may also include a colouring agent so that an operator applying the binder can readily determine, by visual inspection, where he has applied the binder to the top layer. The colouring agent may be a food colouring dye, a vegetable dye or indeed or any other suitable dye.

The liquid binder may further include one or more other components selected from biocides, fungicides, algaecides, herbicides and pesticides.

Embodiments of the method of the second aspect of the present invention utilize similar features and parameters to the embodiments as described with reference to the first aspect of the present invention.

In a third aspect, the present invention provides a binder composition for use in producing a base for a playing field comprising a silicate-based binder, at least one setting agent and a surfactant.

The binder composition suitably comprises a first composition including the silicate-based component and a second composition including at least one setting agent and at least one surfactant, with the first composition and the second composition being mixed to form the binder composition. Suitably, the first composition and the second composition are mixed just prior to application or during application.

The first composition suitably comprises an aqueous-based silicate mixture, preferably an aqueous-based sodium silicate mixture. The first composition may contain from 15 to 50% silicate component, more preferably 15% to 40% silicate component (by weight), with the balance being water and incidental impurities. The first composition is suitably at an alkaline pH, such as a pH of greater than 10.7.

The second composition is suitably a mixture of the one or more setting agents and the one or more surfactants mixed with water. The second composition may include from 1% to 50%, by volume, of the one or more setting agents, preferably from 10% to 45% by volume, more preferably 12% to 40% by volume, of the one or more setting agents.

In some embodiments, the setting agent may comprise an acetate and an organic carbonate, with the setting agent being present in the first composition in an amount of from 12-28%, more suitably from 16-25%, even more suitably from 18 to 22%, by volume.

The second composition may contain from 0.05% to 7% by volume of the one or more surfactants, more suitably from 0.25% to 5% by volume of the one or more surfactants, even more suitably from 0.5 to 2% by volume.

The binder composition may also include a colouring agent to assist an operator to see where the composition has been applied. The colouring agent may be a food dye or a vegetable dye or indeed any other dye. The dye suitably has low or no adverse environmental impacts. The colouring agent is suitably present in the second composition, although it will be appreciated that the colouring agent may also be present in the first composition or added to the binder composition during application.

The one or more setting agents may be as described hereinabove. Any setting agents known to be suitable for setting of silicate binders may be used in the present invention.

The binder composition may also include one or more other components, such as biocides, fungicides, algaecides and pesticides. These components may be added in amounts that are effective in obtaining the desired outcome for those components. The person skilled in the art will readily appreciate the amounts of those components to be added. The other components may be added to the second composition, although it will be appreciated that the other components may also be added to the first composition or to the binder composition during or after application.

The binder composition may be formed by mixing the first composition and the second composition. In this embodiment, the binder composition may comprise from 50% to 80% by volume of the first composition and from 20% to 50% by volume of the second composition, more suitably from 60% to 75% by volume of the first composition and from 20% to 40% by volume of the second composition. Trials using a final mixture of two-thirds first composition and one-third second composition have produced good results.

### BRIEF DESCRIPTION OF THE DRAWINGS

FIG. 1 shows a cross-section of a base in accordance with an embodiment of the present invention used as a lawn bowls base;

FIG. 2 shows a cross-section on a larger scale of part of the cross-section shown in FIG. 1;

FIG. 3 shows a plan view of sub-layer drainage layouts for a lawn bowls layout;

FIG. 4 shows a cross-section of a base in accordance with another embodiment of the present invention use as a lawn bowls base;

FIG. 5 shows a cross-section on a larger scale of a part of the cross-section shown in FIG. 4;

FIG. 6 shows a plan view of sub-layer drainage layouts for the lawn bowls layout shown in FIGS. 4 and 5; and

FIG. 7 shows a cross-section of a base in accordance with a further embodiment of the present invention used as a tennis court base.

### DETAILED DESCRIPTION OF THE INVENTION

It will be appreciated that the attached drawings show preferred embodiments of the present invention and that the invention should not be considered to be limited solely to those embodiments.

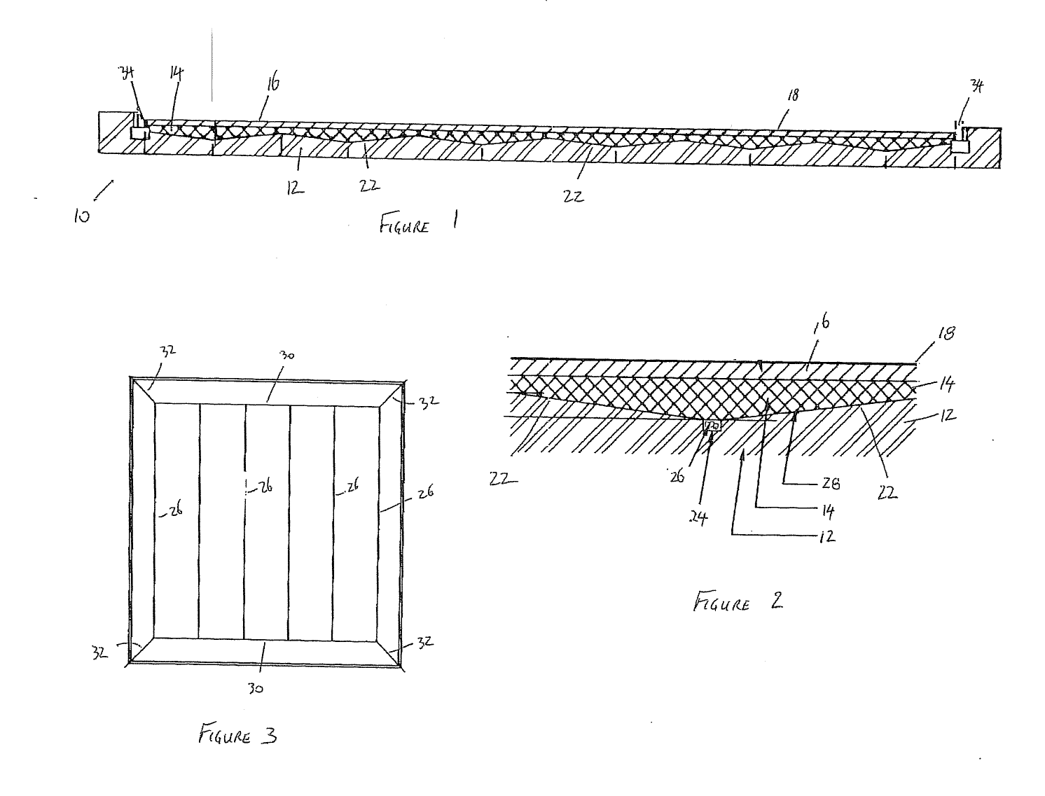

FIGS. 1 and 2 show cross-sectional views of a base for use in a sporting field. In this instance, the base is to be used as a lawn bowls green. The base 10 has the natural subgrade soil or bed rock 12 having a porous layer of road base or filter rock 14 formed thereon and a top layer 16 of finer particulate material. A layer of synthetic turf 18 rests on the upper surface of the upper layer 16.

To form the base 10 shown in FIGS. 1 and 2, the natural subgrade 12 is shaped to have sloped regions 22. Only some of the sloped regions 22 have been numbered in FIG. 1. French drains 24 are positioned at the lower junctions of sloped regions 22. French drains 24 carry away water that has run through the upper layers of the base. The French drains 24 are suitably filled with a course aggregate 26.

As shown in FIG. 2, it is also desired to place a geofabric or geotextile liner 28.

Once the sublayer has been appropriated shaped and the sublayer drainage installed, the geotextile liner 28 is placed onto the prepared sublayer and the layer 14 of road base or filter rock is then placed over the sublayer. The layer 14 suitably has a perfectly level upper surface. Layer 14 is preferably compacted and laser leveled during installation. Layer 14 provides a firm basis for the upper layer 16 and also allows for water to flow therethrough.

A typical particle sized distribution for the road base or other material used in layer 14 is shown in Table 1.

TABLE 1

| | |
|---|---|
| Sieve Size | % Passing |

| | | |
|---|---|---|
| 75.0 | mm | 100 |
| 53.0 | mm | 100 |
| 37.5 | mm | 100 |
| 26.5 | mm | 100 |
| 19.0 | mm | 100 |
| 16.0 | mm | 94 |
| 13.2 | mm | 88 |
| 9.5 | mm | 72 |
| 6.7 | mm | 59 |
| 4.75 | mm | 48 |
| 2.38 | mm | 33 |
| 1.18 | mm | 25 |
| 0.600 | mm | 19 |
| 0.425 | mm | 18 |
| 0.300 | mm | 16 |
| 0.150 | mm | 12 |
| 0.075 | mm | 9 |

The uppermost layer or top layer 16 is then laid over layer 14. Top layer 16 preferably comprises a crusher dust material, a manufactured sand or a cement-based sand. Where silicate binders are used, the use of silicate sand should be avoided as the silicate sand does not bind well with silicate based binders.

A typical particle sized distribution for the particulate material used in the top layer 16 as shown in Table 2.

TABLE 2

| | Total Mass | |
|---|---|---|
| Size (mm) | Passing (g) | % Passing |
| 2.36 | 42.7 | 14.9 |
| 1.18 | 102.6 | 35.8 |
| 0.80 | 58.4 | 20.4 |
| 0.425 | 30.1 | 11.9 |
| 0.30 | 2.05 | 0.2 |
| 0.15 | 21.3 | 7.5 |
| 0.075 | 13.0 | 4.6 |
| 0.05 | 12.8 | 4.5 |
| Total . . . | 286.7 | |

The top layer 16 is suitably compacted and laser levelled, if required. At this stage, the top layer 16 comprises a layer of compacted, leveled, particulate material. Although this layer has been compacted, this material can be easily removed from the upper layer.

In order to provide a stronger surface, a binder is applied to the upper surface of the top layer.

The binder that is used suitably penetrates a distance of from 5 mm to 150 mm into the top layer 16. Ideally, the binder penetrates at least 15 mm into the top layer. More preferably, the binder penetrates from 20 mm to 50 mm into the top layer, more suitably 20 mm to 35 mm.

The preferred binder for use in the present invention comprises a silicate-based binder.

### Example

The final binder mixture used in this example was obtained by spraying 2 parts by volume of a first composition with 1 part by volume of a second composition onto the prepared particulate layer. The first composition contained silicate and the second composition contained the setting agent. Both the first and second compositions were aqueous-based compositions. The first composition and the second composition were stored in separate drums or containers and mixed together using a metering pump that provided the mixed final composition to a sprayer.

The first composition was either O-grade sodium silicate purchased from PQ Corporation. O-grade sodium silicate has a water content of from 59.5 to 60.5%, whilst the N-grade sodium silicate has a water content of from 61.9 to 62.9%. The balance is essentially sodium silicate.

The second composition contained the setting agent(s), surfactant(s) and other ingredients, such as colouring agents, solvents for the colouring agents and preservatives or biocides. Examples of suitable compositions for use as the second composition are set out in Table 3:

TABLE 3

| | | | MOST |
|---|---|---|---|
| CHEMICAL | USEFUL % | PREFERRED % | PREFERRED % |
| Ethylene Glycol | 12-22% | 15-20% | 16-18% |
| Di Acetate | | | |
| Propylene | 0-6% | 1-5% | 2-4% |
| Carbonate | | | |
| Surfactant | 0.05-7% | 0.25-5% | 0.5-2% |
| Bronopol | 0.01-0.06 | 0.02-0.05 | 0.03-0.04 |
| Ethanol | 1.0% | 1.0% | 1.0% |
| Blue Dye | 0.05 | 0.05 | 0.05 |
| Water | Balance | Balance | Balance |

An illustration of a suitable surfactant would be a blend of an alcohol ethoxylate and a tetrafluoroethylene telomer. The setting agents used in this example is a mixture of ethylene glycol diacetate and propylene carbonate.

The Bronopol is present as a preservative, to protect potentially biodegradable surfactants from premature degeneration. The ethanol is present since it is used to dissolve the dye to facilitate the production process. Investigations indicate that the ethanol plays no part in the process, but has no deleterious effects either.

Once the binder has set, the upper part of the top layer 16 is bound together such that the particles in the upper part of the top layer are very difficult to dislodge. Indeed, tests have shown that the bound part of the top layer can have a strength of between 5 MPa and 18 MPa. Surprisingly though, the bound upper part of the top layer 16 retains significant porosity and this allows water to pass through the bound top layer. Accordingly, the base of the present invention provides a very strong upper surface that can be made perfectly level without the risk of pooling of water on the upper surface.

The binder composition may also include an algaecide or a biocide to assist in suppressing the growth of algae in the base. It has been found that algal growth in the base can occur, particularly in warmer and wet climates.

FIG. 3 shows a plan view of the layout of drains that may be used. In FIG. 3, a plurality of French drains 26 (only some of which have been numbered) run into end French drains 30 which, in turn, drain into outlet drains 32. It will appreciate that other drainage layouts may also be used in the present invention.

Returning now to FIG. 1, it can be seen that the bowling green includes edge gutters 34 that remove excess surface water following rain and also act to catch stray bowling balls.

The bowling green is completed by laying synthetic turf on top of the bound upper part of top layer 16. The synthetic turf is typically laid over the bound upper part of the top layer 16 and further particulate material (such as sand or pulverized rubber) then placed on top of the synthetic turf to assist in retaining the synthetic turf in place.

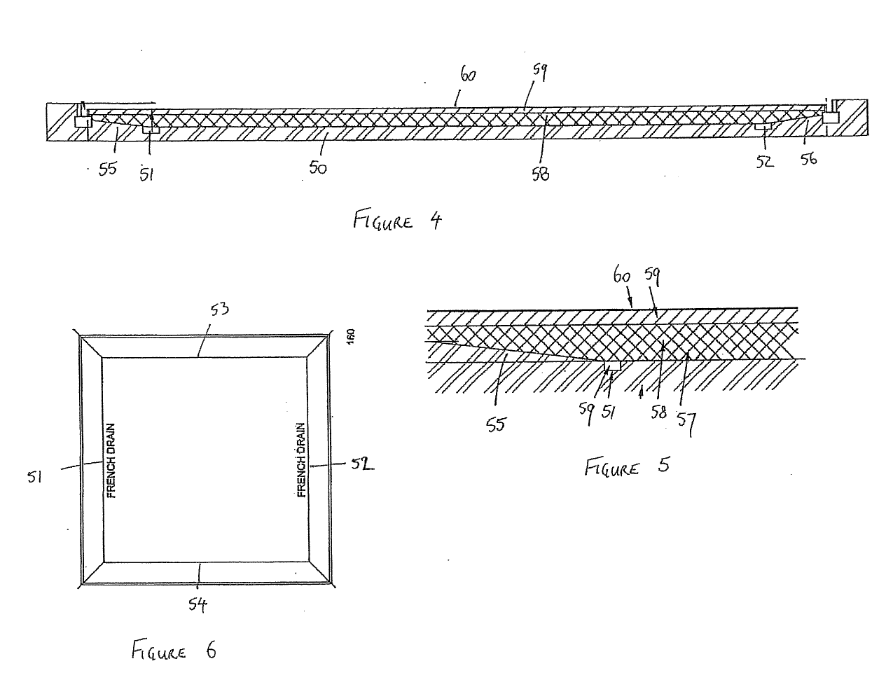

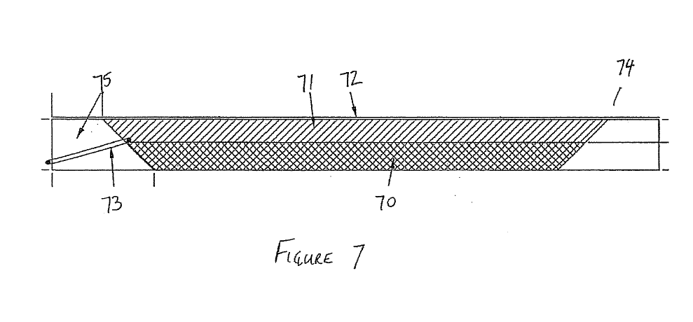

FIGS. 4 to 6 show an alternative base suitable for use as a lawn bowls green. The base shown in FIGS. 4 and 5 comprises a sub-base layer 50. Sub-base layer 50 includes drains 51, 53, 54. The portions of the sub-base layer 55, 56 located outwardly from the drains is sloped, as shown in FIGS. 4 and 5. In this fashion, water percolating through the base runs into drains 51 and 52. Suitably, there is a slight fall in the central region 50 such that water runs across the sub-base layer into the drains 51 or 52.

Sub-layer 50 is suitably made by preparing the ground in the location of the lawn bowls green. The drains 51, 52, 53, 54 are suitably filled with a drainage aggregate 59.

A geofabric liner 57 is placed over the sub-layer 50 and a selected porous road base layer 58 is then laid on top. The layer of particulate material 59 is then laid on top of the sub-layer 58 and the liquid binder applied thereto. After the binder has set, an artificial grass layer 60 is applied to the top to complete the playing surface.

The lawn bowls green shown in FIGS. 4 to 6 is generally similar to that shown in FIGS. 1 to 3, with the exception that the shaping of the lowermost ground layer and the position of the drains has been altered.

FIG. 7 shows a cross-sectional view of a base that may be used for a tennis court. The base shown in FIG. 7 includes a sub-layer 70 having a layer 71 of particulate material formed thereon. The liquid binder is applied to layer 71 and allowed to set, after which a synthetic grass layer 72 is applied to the top. Drainage pipes, such as the one shown at 73, are laid on the low sides of the court to allow for drainage of water that percolates through the layer 71. In the tennis court shown in FIG. 7, it will be appreciated that there is a fall or slope from side 74 to side 75, which fall or slope allows water to be drained from the tennis court.

If it is decided to build a tennis court with minimal falls, such a fall of less than 0.25%, it may be possible to construct a tennis court base that has a structure similar to the structure of the bowling greens shown in FIG. 1 or 4, with appropriate sizing changes made such that the base is of the correct size for a tennis court. This allows for adequate sub-layer drainage even if there is little fall in the top of the tennis court.

Although the preferred embodiments shown in FIGS. 1 to 7 relate to lawn bowls greens or tennis courts, it will be appreciated that the present invention is applicable to other sporting fields and playing surfaces as well. For example, the present invention may be used in American football fields, soccer fields, multi-sports fields, field hockey fields, children's play areas and rugby football fields. Indeed, the present invention may be used to make playing fields and playing surfaces for any use.

Those skilled in the art will appreciate that the present invention may be subjected to variations and modifications other than those specifically described. It is to be understood that the present invention encompasses all such variations and modifications that fall within its spirit and scope.

1. A base for a playing field comprising a layer of particulate material, said layer forming at least an upper part of the base, and a binder applied to the layer of particulate material, the binder extending from about 5 mm to about 150 mm into the layer of particulate material, the binder acting to bind at least the uppermost part of the layer of particulate material, said layer being porous to water such that water applied to a surface of the base flows through said layer.

2. A base for a playing field as claimed in claim 1 wherein the particulate material in the top layer is sized such that the particulates predominantly fall within the size range of 0.025 mm to 25 mm.

3. A base for a playing field as claimed in claim 2 wherein the particulate material in the top layer is sized such that the particulates predominantly fall within the size range of from 0.025 mm to 10 mm.

4. A base for a playing field as claimed in claim 2 wherein the particulate material is sized such that the particles predominantly are sized below 5 mm.

5. A base for a playing field as claimed in claim 1 wherein the particulate material is a crushed stone, a manufactured sand, a concrete crushed stone or a crusher dust.

6. A base for a playing field as claimed in claim 1 wherein the layer is laid directly onto an underlying concrete or asphalt base or is laid onto an underlying layer of particulate material.

7. A base for a playing field as claimed in claim 6 wherein the underlying layer of particulate material is a layer of graded particulate material having high permeability to water.

8. A base for a playing field as claimed in claim 7 wherein the underlying layer of particulate material comprises a graded layer having particles largely in the range of 7 mm to 22.5 mm.

9. A base for a playing field as claimed in claim 7 wherein, sub-surface drainage is incorporated beneath the top layer.

10. A base for a playing field as claimed in claim 7 wherein a sub-layer has falls or slopes built-in during construction to enable water to run off the sub-layer.

11. A base for a playing field as claimed in claim 1 wherein the binder extends from about 5 mm to about 100 mm into the layer of particulate material.

12. A base for a playing field as claimed in claim 11 wherein the binder penetrates at least 10 mm into the layer of particulate material.

13. A base for a playing field as claimed in claim 12 wherein the binder penetrates from 20 mm to 25 mm into the layer of particulate material.

14. A base for a playing field as claimed in claim 1 wherein the binder comprises a silicate-based binder and further includes one or more setting agents.

15. A base for a playing field as claimed in claim 14 wherein the binder further includes one or more surfactants.

16. A method for forming a base for a playing field comprising: forming a base having at least an upper layer of a particulate material sized such that the particles predominantly fall within a size range of 0.025 mm to 10 mm; and applying a liquid binder to the top layer such that the liquid binder penetrates a distance of from 5 mm to 100 mm into the top layer and sets to bind the particulate material in the top layer; wherein said top layer retains porosity to water.

17. A method as claimed in claim 16 wherein the liquid binder comprises a silicate-based binder.

18. A method as claimed in claim 17 wherein the silicate-based binder incorporates a silicate component and one or more setting agents.

19. A method as claimed in claim 18 wherein the binder comprises a first composition including the silicate component and a second composition including the one or more setting agents and the first composition and the second composition are mixed just prior to application of the binder to the top layer, or mixed as part of the application process for applying the binder to the top layer.

20. A method as claimed in claim 19 wherein the second composition further includes one or more surfactants.

21. A method as claimed in claim 16 wherein the liquid binder further includes a colouring agent so that an operator applying the binder can readily determine, by visual inspection, where the binder has been applied.

22. A method as claimed in claim 16 wherein the liquid binder comprises at least one of biocides, fungicides, algaecides, herbicides and pesticides.

23. A method as claimed in claim 16 wherein the binder is applied to the layer of particulate material at an application rate of from 0.5 litre per square metre to 10 litres per square metre.

24. A method as claimed in claim 23 wherein the binder is applied to the layer of particulate material at an application rate of from 1 litre per square metre to 7 litres per square metre.
